(19) United States
(12) Patent Application Publication
(10) Pub. No.: US 2004/0237088 A1
(43) Pub. Date: Nov. 25, 2004

(54) Job distributing method in a distributed computer system

(76) Inventors: Yoshio Miki, Kodaira (JP); Kazuhiko Mizuno, Hachioji (JP)

Correspondence Address: Mattingly, Stanger & Malur, P.C., Suite 370, 1800 Diagonal Road, Alexandria, VA, 22314, US

(21) Appl. No.: 10/645,527

(22) Filed: Aug. 22, 2003

(30) Foreign Application Priority Data
May 20, 2003 (JP) 2003-141292

(51) Int. Cl. G06F 9/00

(52) U.S. Cl. 718/102

(57) ABSTRACT

A JOB distribution control method for a plurality of Computer Service Centers connected via a network represented by the Grid is provided. When a JOB request occurs in a first Computer Service Center, a current average JOB request interval of the first Computer Service Center is calculated. The necessary number of servers for achieving a predetermined JOB response time is calculated from a predetermined standard JOB request interval, a predetermined standard JOB execution time of servers, and the calculated current average JOB request interval. Only when the number of the servers in the first Computer Service Center is over the calculated necessary number, the JOB request is transmitted to a remote second Computer Service Center.

### FIELD OF THE INVENTION

The present invention relates to a method for distributing JOB executions to a plurality of computers in a Computer Service Center managing computers, in particular, to a JOB control software technique for cooperation among a plurality of Computer Service Centers connected via a wide area network such as the Grid and the Internet.

### BACKGROUND OF THE INVENTION

In a Computer Service Center having a plurality of computers, JOBs are distributed to the computers so that loads of the computers become as even as possible. This distribution is called load balancing, which is achieved by a load balancer for a data center, or the Computer Service Center connected to the Internet. As disclosed, for example, in the Internet website (hppt://online.plathome.co.jp/products/clikarray/index.p html), round robin and IP hashing, where JOBs requested to be executed are evenly distributed in available computers, are known as the methods of the balancer. These methods are effective as the load balancing when JOBs are assumed to be completed during almost the same process time. However, when JOBs whose process time requests are unknown are treated, a load of each computer needs to be observed to distribute the JOBs. Such a JOB distribution technique is disclosed in U.S. Pat. No. 5,481,698 or JP-A No.265955/1993. Loads of computers under JOB execution are observed to run JOBs at computers having small loads. When the computers are widely located on a network such as the Grid and the Internet in a distributed manner, all the usable computers are evenly used by means of the load balancing using the round robin or IP hashing. In the load observing method, the loads of the computers are queried via the network, and JOB distribution is controlled in accordance with load information obtained from a result of the query.

As described above, in the round robin and IP hashing, all the usable computers are targets to which JOBs are distributed. When a plurality of Computer Service Centers are connected via the network, it is more convenient to differently use the Computer Service Center near a JOB occurrence point and ones remote from the point. Concretely, it is preferable that a JOB is executed in a Computer Service Center where the JOB occurs as long as there is execution capacity in the computers of the Computer Service Center, and that, when there is no execution capacity, the JOB is executed in a remote Computer Service Center. However, in the method for evenly distributing JOBs, even when there is additional capacity in the Computer Service Center where the JOB execution request occurs, the JOB may be distributed to the remote Computer Service Center.

Even when the load observing method is used to avoid this problem, loads are observed via the Grid and the Internet in this method, so that the load observing time cannot but include a delay time of the network. As a result, loads of the computers are wrongly recognized. In other words, when a JOB is run at the remote Computer Service Center, additional times via the network are required for the procedure between the run decision and start of the JOB, and for a report about the load observation of the computers at the remote Computer Service Center. As a result, the loads are observed just before the JOB execution, so that the loads may be wrongly recognized small. As described above, in the related arts, the fact that computers are widely located in a distributed manner via the network such as the Grid is not considered as important.

### SUMMARY OF THE INVENTION

An object of the present invention is to provide a method where, in load balancing and JOB distribution of computers of Computer Service Centers which are connected via a network such as the Grid and widely distributed, when there is additional capacity in a Computer Service Center where a JOB occurs, the JOB is executed in the Computer Service Center, and when a remote Computer Service Center is used, JOBs are evenly distributed regardless of a delay time of the network.

The object is achieved through the following method. A local center is a Computer Service Center where JOB execution requests occur. Remote centers are remote Computer Service Centers connected via a network to the local center. A desired JOB response time is predetermined, an average value of times for running JOBs, and an average value of times for executing JOBs are input, and thereby the necessary number of servers is determined to achieve the response time. When the necessary number is overa criterion of the local center, the JOB is executed in the remote server, so that proper JOB distribution is achieved without observing loads of the computers.

### BRIEF DESCRIPTION OF THE DRAWINGS

FIG. 1 is a flowchart showing an embodiment of the present invention;

FIG. 2 is a flowchart showing operations of another embodiment including accounting management;

FIG. 3 is a block diagram showing a system configuration of the embodiment of FIG. 1;

FIG. 4 is a block diagram showing a system configuration of further embodiment;

FIG. 5 is a flowchart showing operations of the embodiment of FIG. 4;

FIG. 6 is a block diagram showing a detailed configuration of servers of the embodiment of FIG. 1 or 2;

FIG. 7 is a flowchart showing detailed operations of the embodiment including a JOB queuing operation;

FIG. 8 is a flowchart showing a queue control method.

FIG. 9 is a queue model for showing the principle of the present invention; and

FIG. 10 is a time sequence showing a business embodiment of the present invention.

### DETAILED DESCRIPTION OF THE PREFERRED EMBODIMENTS

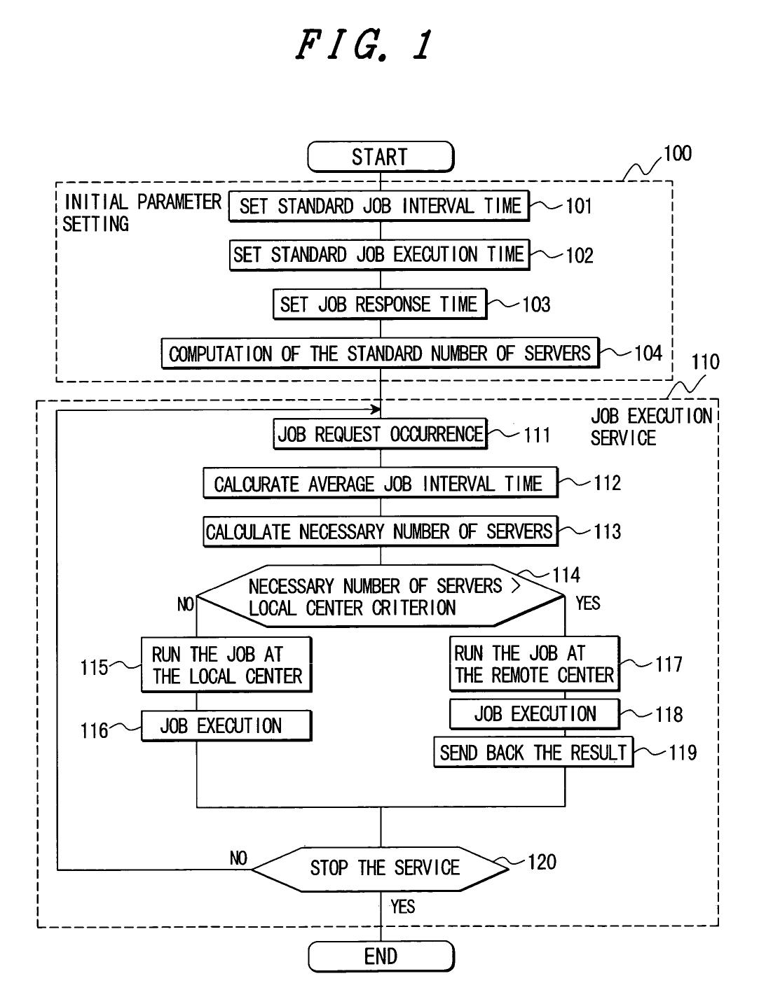

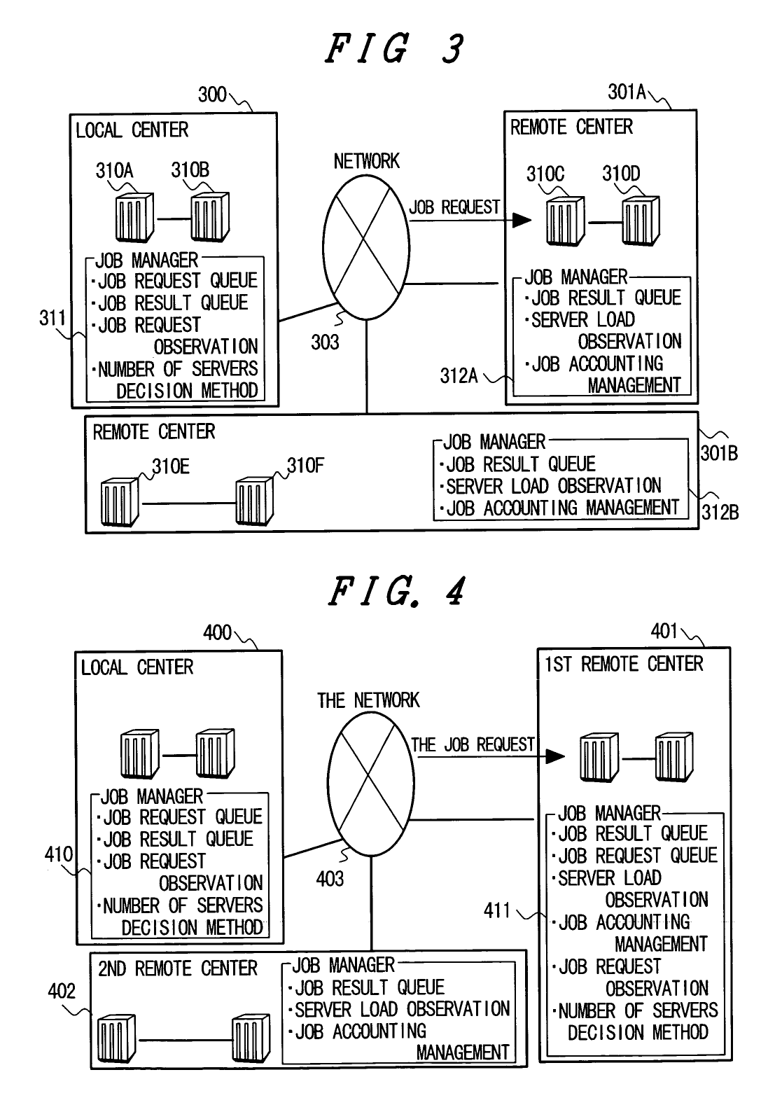

FIG. 1 shows an operation flow of a computer system according to an embodiment of the present invention. FIG. 3 shows a configuration of the computer system.

In FIG. 3, a local center 300 is a Computer Service Center where JOB requests occur and where servers 310a and 310b are contained. The server 310a, 310b, or both, as after-mentioned in detail, mounts a JOB manager 311 as a program, which achieves functions required for embodying the present invention, such as a JOB request queue, JOB result queue, JOB request observation, and decision of the number of servers. Remote centers 301a and 301b are Computer Service Centers connected via the local center 300 and a network 303. The local center 300 and the remote centers 301a and 301b are supposed to be physically widely located in a distributed manner. The remote center 301a, like the local center 300, includes servers 310c and 310d, either of which servers includes a JOB manager 312a as a program. The remote center 301a mounts a server load observation method and a JOB accounting management system, in addition to the JOB result queue. Like the remote center 301a, the remote center 301b includes servers 310e and 310f, either of which servers includes a JOB manager 312b as a program. Referring to FIG. 1, a JOB distributing method of the present invention achieved by the JOB manager 311, 312a, or 312b is explained. The whole processing procedure is mainly divided into initial parameter setting 100 and JOB execution service 110. In the initial parameter setting 100, the number of servers generally used in the local center and remote centers and a time from occurrence of a JOB request to an end of the JOB, in other words, standard values including a JOB response time, are set. More concretely, a standard JOB interval time, which is an average time of JOB request intervals, is set (101), and a standard JOB execution time, which is a standard time between a start and end of JOB execution on servers, is set (102). The aforementioned JOB response time is set as a design value, which is a desired time for the whole system including the local center and remote centers (103). From these set values, a standard value of the necessary number of the servers required for the whole system is determined by the after-mentioned method for computing the number of the servers (104).

AS described above, in the initial parameter setting 100, values related to operations of the whole system are determined, and in the JOB execution service 110, the operations of the whole system which, until there is no JOB request, continues semi-permanently are defined. First, when a JOB request occurs in the local center, the time difference between the JOB request and the preceding JOB request is calculated to calculate the average time of the JOB intervals (112). The average time can be calculated by the following two methods. One is such that a period for observing JOB requests is additionally set to calculate the average time interval of the JOB requests occurring during the period until a current time. In this method, when the JOB request interval changes, the change can be rapidly recognized. Another is such that the JOB request interval times are summed up and then divided by the number of the JOB requests to determine the average value. This method is easily achieved, where, however, when the JOB request interval changes, the change cannot be easily detected.

When the average value of the JOB request interval times is calculated, the average value and a result of the initial parameter setting 100 are combined, so that the JOB response time which is set for the whole system and the average time of the JOB executions on the servers are prepared. Then, the necessary number of the servers for achieving the set JOB response time is calculated by the after-mentioned theoretical equations (113). Only when the necessary number is over a criterion predetermined for the local center (114), a JOB is run at servers of the remote centers (117). The run JOB is executed in the remote center (118), and a result of the JOB is sent back to the local center (119).

The number of the servers available in the local center is basically used as a criterion used for judging the necessary number of the servers (114). Additionally, for example, the number of JOBs which can be simultaneously executed in the server is set, and multiplied by the number of the servers, which products can be set as the criterion. When the necessary number of the servers is within the criterion (114), a JOB is run at the servers on the local center (115), and executed (116). The essential process of the present invention is as follows. In the whole system comprised of the local center and remote centers, to achieve a desired JOB response time, JOBs are executed in the local center as long as capacity of the servers of the local center is enough to execute JOBs. This process continues until an outside request to stop operation of the local center occurs (120).

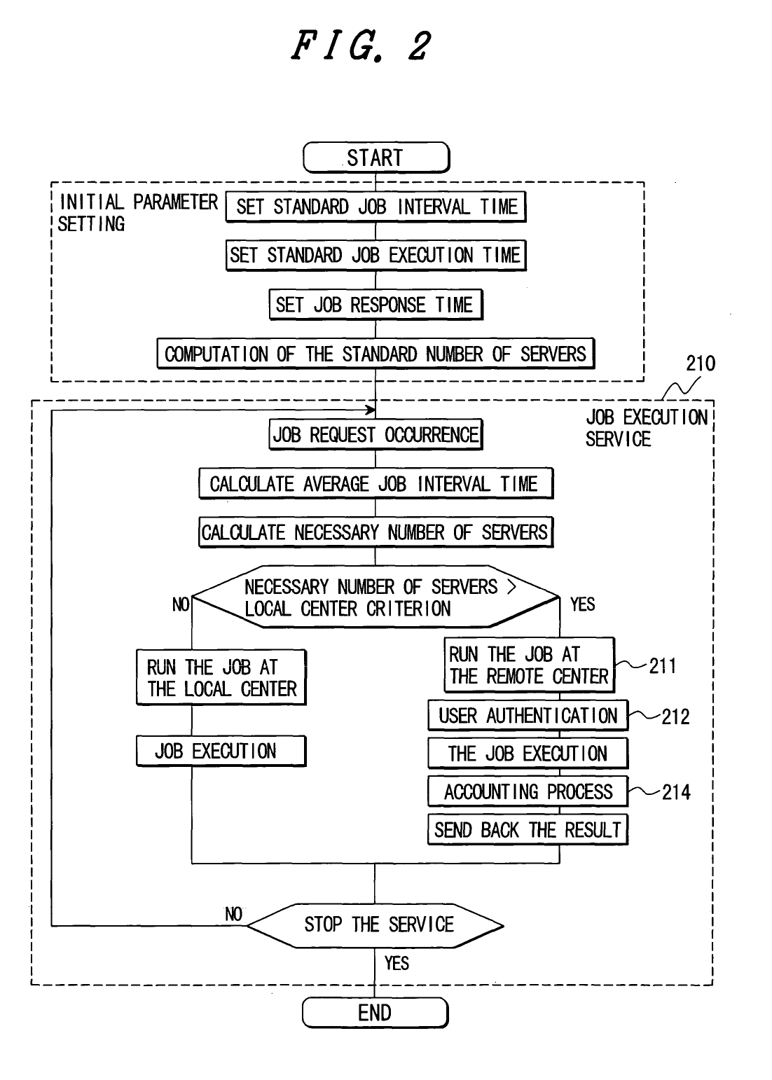

The essence of the present invention has been explained above. Referring to FIG. 2, another embodiment related to JOB execution in a remote center is explained. In JOB execution service 210 of FIG. 2, after a JOB is run at servers of the remote center, the user is authenticated (212). Concretely, when a JOB is run at the servers of the remote center, ID information on the user, who requests the JOB at the local center, and the JOB are simultaneously transmitted to the remote center. For example, the user ID can use an ID managed by a password file of the UNIX (registered trademark) operating system. In the present invention, when the Computer Service Centers automatically transmit the JOBs to each other, it is complicated to manage, in the remote centers, all users of the local center. In this case, instead of the user ID, a group ID can be used in the user authentication 212. Also the group ID can use a group ID of the UNIX (registered trademark) operating system. As described above, the authentication process is provided to charge a unit of a user or user group for use of the remote centers (214). In the embodiment of FIG. 2, except for the running of the JOB at the remote center 211, user authentication 212, and accounting process 214, the same operations as the embodiment of FIG. 1 are executed. Therefore, in the embodiment of FIG. 2, when JOB execution within a desired response time cannot be achieved only by the servers in the local center, the cost occurs.

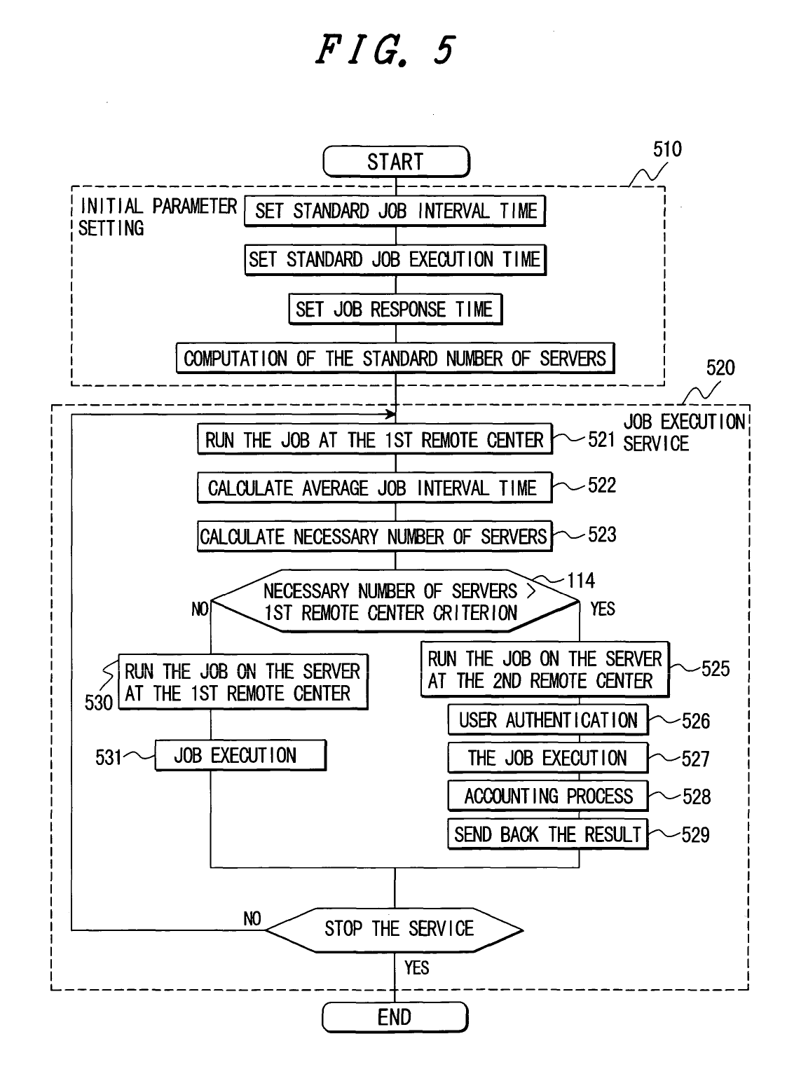

Referring to a block diagram of a system of FIG. 4 and to a flowchart of FIG. 5, another embodiment is explained. In FIG. 3, the local server 300 where a JOB request occurs, using the method shown in FIG. 1 or 2, determines the number of servers, and runs a JOB at remote center 301a or 301b. A system configuration of the embodiment of FIG. 4 is as follows. A local center 400, where a JOB request occurs, runs the JOB at a first remote center 401. The first remote center 401 calculates the number of servers by means of the same method as the local center 400, and runs the JOB at a second remote center 402. In this case, a JOB manager 411 of the first remote center 401 requires the same configuration as the JOB manager 410 of the local center 400.

FIG. 5 concretely shows a JOB control method in the first remote center. Initial parameter setting 510 is exactly the same as the local center 400. A JOB response time which is set in the JOB manager 411 is one required for the whole system, so that it is exactly the same as the JOB manager 410. It is also effective that the JOB response time for the JOB manager 411 is set smaller than that for the JOB manager 410 in consideration of time loss generated by transmissions of the JOB request and JOB execution result between the local center 400 and the first remote center 401. A standard JOB request interval and standard JOB execution time which are set in the JOB manager 411 are basically the standard JOB request interval of the first remote center and the standard JOB execution time of the servers in the first remote center. By use of a set value of a standard JOB request interval common to the local center and first remote center, and by use of a standard JOB execution time common to servers of both centers, the necessary number of the servers for the first remote center can be calculated without problems.

In JOB execution service 520 executed by the first remote center 401, the same process as the JOB execution service executed by the local center 400 is executed. First, when the local center 400 runs a JOB request at the first remote center 401, the first remote center 401 recognizes the occurrence of the JOB execution request (521) Next, an average value of JOB request intervals is calculated (522), and the necessary number of the servers is calculated from a standard time interval of running JOBs, which time interval is determined in the initial parameter setting 510, an average execution time of the executions on servers, and a desired JOB response time. When the necessary number is over a criterion of the first remote center 401 (524), the JOB is run at servers on the second remote center. When the necessary number is under the criterion of the first remote center 401, a JOB is run at servers on the first remote server (530), and executed (531). Accounting management is necessary when a plurality of the remote centers are concerned. The second remote center executes user authentication 526 in accordance with user information transmitted from the first remote center, executes accounting process 528 after JOB execution 527, and sends back a result of the execution to the first remote center (529).

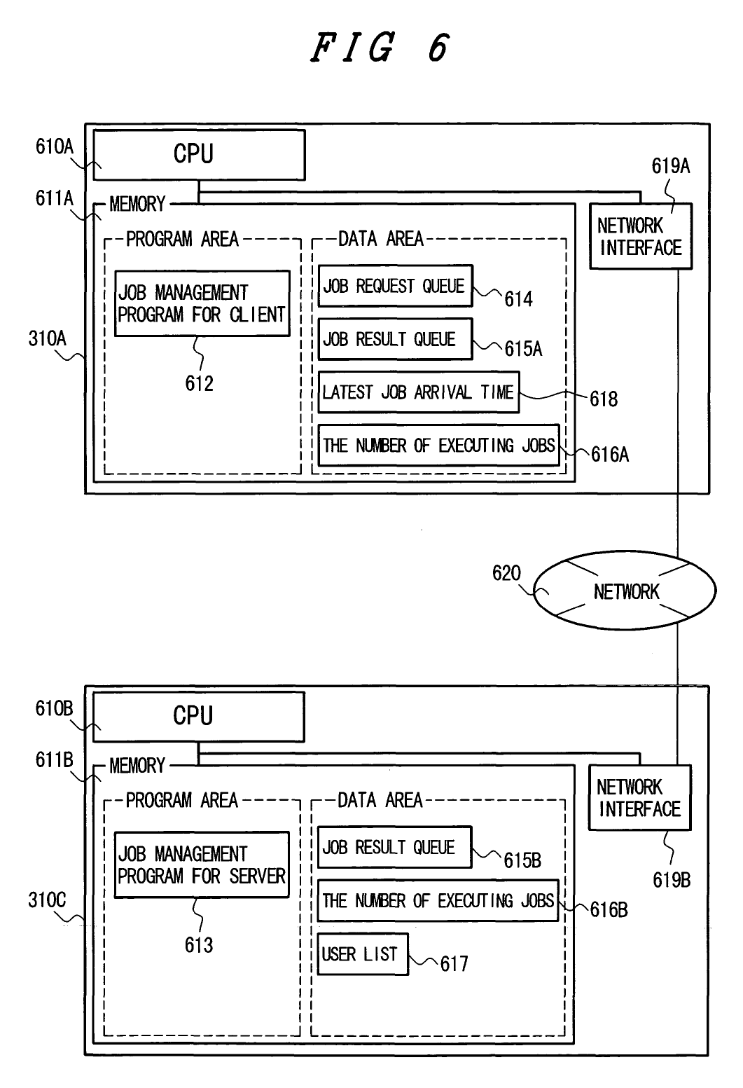

Referring to FIG. 6, relationship between the JOB managers and servers of FIGS. 1 and 3 is explained in detail. The server 310a is equipped in the local center. The server 310c is equipped in the remote center. The server 310a includes a CPU 610a and memory 611a for executing a program and a network interface 619a. Also the server 310b includes a CPU 610b, a memory 611b, and a network interface 619b. The memories 611a and 611b are each divided into a program area and data area. The JOB managers of FIG. 1 are stored as a JOB management program 612 for clients (for a local center) and a JOB management program 613 for servers (for a remote center) in the program areas. When a JOB is run at the servers of the local center of FIG. 1 (115) and when a JOB is run at the servers of the remote center (117), the number of executing JOBs on the servers is managed as the number of executing JOBs 616a and 616b. When the number of executing JOBs is non-zero or over a criterion, the JOB is judged not to be immediately executed, queued in a JOB request queue 614, and waits to be executed until a condition for releasing the JOB from the queue is satisfied, which condition is after-mentioned. In average JOB interval time calculation 112, times of previously-generated JOB requests and the sum of the JOB request intervals need to be stored, so that an area for a latest JOB arrival time 618 is saved in the data area. The JOB which has ended its execution is queued in a JOB result queue 615b of the remote center, and sent back to the local center immediately when the local center can receive the result. In the user authentication 212 of FIG. 2, authentication of a user or group who can use the remote center is required. Information required for the authentication of their passwords is stored as a user list 617.

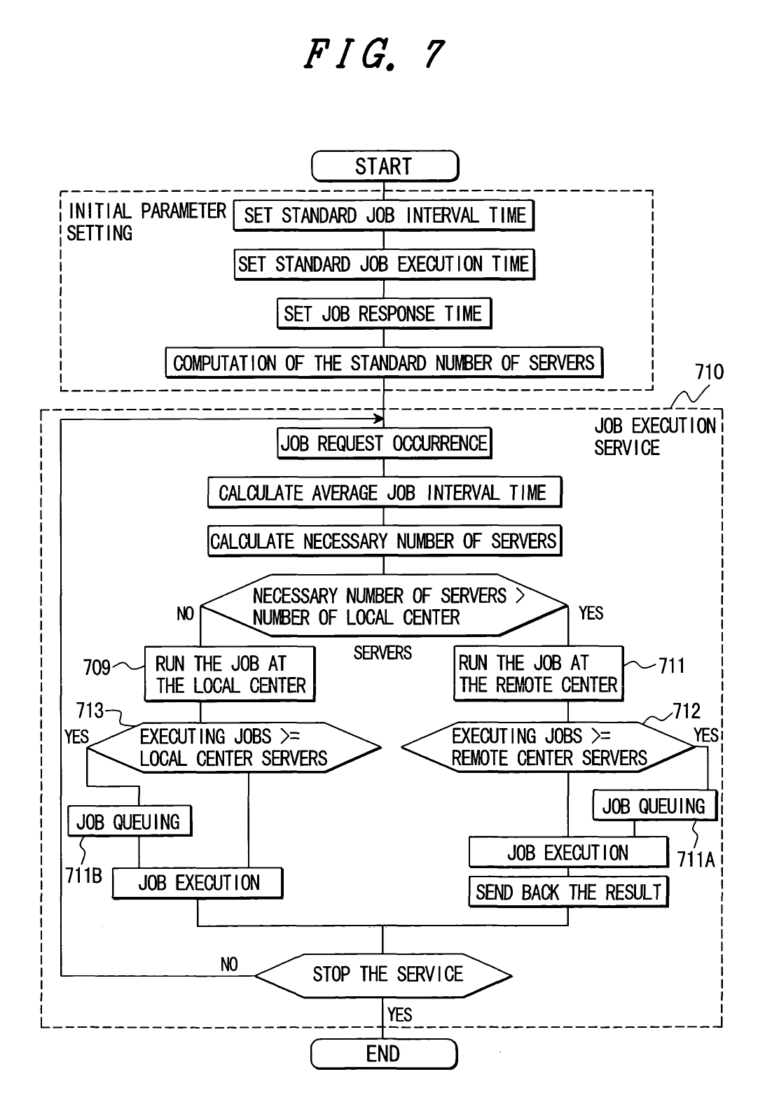

FIG. 7 shows a detail flow of the above-described JOB control method, including the JOB request queues. When a JOB is run at the servers of the remote center in JOB execution service 710 (711), a value of the number of executing JOBs is obtained from the number of executing JOBs 616b to judge whether the value is over the number of servers in the remote center (712). When the value is over the number, the immediate execution is impossible, so that the JOB is queued in the JOB request queue 614 (711a). When a JOB is run at the servers of the local center (709), as well as of the remote center, a value of the number of executing JOBs is obtained from the number of executing JOBs 616a to judge whether the value is over the number of servers of the local center (713). When the value is over the number, the JOB is queued in the JOB request queue 614 (711b).

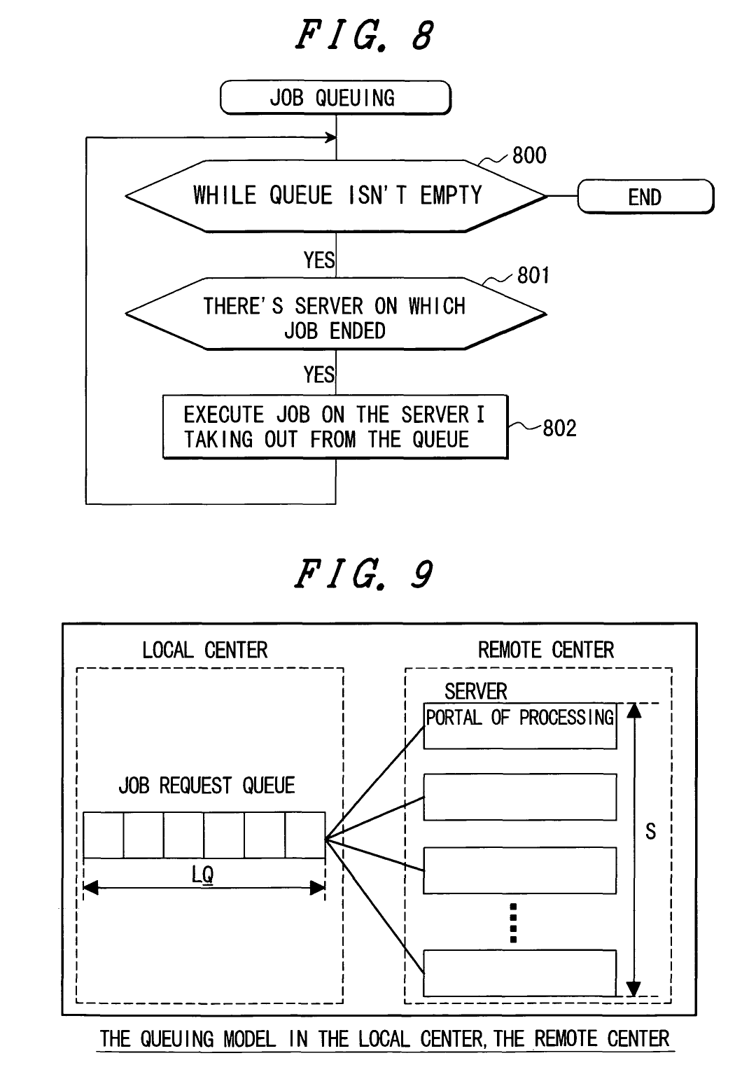

FIG. 8 shows the operation when the JOB is taken out from the JOB request queue 614 and executed. In the JOB queuing process shown in FIG. 7, it is always checked whether the JOB request queue is empty (800). When not empty, a server where a JOB ended is sought (801). When there is the server where the JOB ended, another JOB is taken out from the queue and executed on a server (802). This process is repeated until the queue becomes empty. The basic JOB control method has been explained above.

Next, a method for calculating the necessary number of servers 113, represented by FIG. 1, is explained, including its theoretical background and precondition.

Job requests are considered to randomly occur. This means random arrival of the queuing theory. The time while a JOB is executed on servers is considered to randomly changes. The sum of the times while a JOB exists in a queue and while the JOB is being executed are defined as a response time. The servers are considered as process windows of the queuing theory. The number of the servers, in other words, the number of the windows, is defined as s. FIG. 9 shows a modeled image of these definitions.

The average time of JOB request intervals is 1/λ. The average JOB execution time on servers is 1/μ. The probability that the queue length is n is Pₙ. The following equations hold from the queuing theory having s of windows.

(Equations 1)

μp₁=λp₀ Equation (a)

λpₙ₋₁+(n+1)μpₙ₊₁=(λ+nμ)(1≦n≦s−1) (Equation (b)

λPₙ₋₁+sμpₙ₊₁=(λ+sμ)pₙ (Equation c)

When a=λ/μ is defined as a ratio of JOB request/JOB execution time, and when p=a/s is defined as an index of the system stability, the following equations are derived from equations (a) and (b) of (Equations 1).

$$\begin{matrix}{p}_{1} = {ap}_{0} \\ {p}_{n} = \frac{{a}^{n}}{n !} {p}_{0} ( 0 ≦ n ≦ s )\end{matrix} \qquad ( Equations 2 )$$

When n≧s, consecutive members of pₙ of equation (c) of (Equations 1) are rearranged, so that the following equation holds.

sμ(pₙ₊₁−pₙ)=λ(pₙ−pₙ₋1) (Equation 3)

From a boundary condition of n=s, (Equation 4) holds, so that (Equation 5) is obtained.

sμpₛ=λpₛ₋₁ (Equation 4)

$${p}_{n} = \frac{{a}^{n}}{s ! {s}^{n - s}} {p}_{0} = \frac{{s}^{s} {ρ}^{n}}{s !} {p}_{0} \qquad ( Equation 5 )$$

From Σpₙ=1, p₀ is as follows.

$${p}_{0} = \frac{1}{{\sum }_{n = 0}^{s - 1} \frac{{a}^{n}}{n !} + \frac{{a}^{s}}{( s - 1 ) ! ( s - a )}} \qquad ( Equation 6 )$$

From the above equations, a complete solution of pₙ is obtained, so that the following indexes of the modeled local center and remote center can be obtained.

Length of JOB Request Queue L_{q}:

$${L}_{q} = {\sum }_{n = 1}^{∞} n {p}_{n} = \frac{λ μ {a}^{s}}{( s - 1 ) ! {( s μ - λ )}^{2}} \qquad ( Equation 7 )$$

Wait Time in JOB Request Queue W_{q}:

$${W}_{q} = {L}_{q} \frac{1}{λ} = \frac{μ {a}^{s}}{( s - 1 ) ! {( s μ - λ )}^{2}} \qquad ( Equation 8 )$$

JOB Response Time W:

$$W = {W}_{q} + \frac{1}{μ} \qquad ( Equation 9 )$$

In accordance with the above-described equations, in equilibrium of the whole system, a JOB response time can be expressed as a function of JOB request time interval 1/λ. Therefore, regardless of change of JOB request condition, the necessary number of windows (servers) can be determined to keep a constant response time.

$$\frac{ⅆ W ( λ )}{ⅆ λ} = \frac{ⅆ}{ⅆ λ} [ \frac{μ {a}^{s}}{( s - 1 ) ! {( s μ - λ )}^{2}} + \frac{1}{μ} ] = 0$$

This equation can solve s by assuming (p0)′=0. Therefore, to keep a response time constant regardless of change of the frequency of JOB inputs, the necessary number of servers s is determined by the following equation.

$$s = \frac{a + \sqrt{{a}^{2} - 8 a}}{2} \qquad ( Equation 11 )$$

As described above, the necessary number of the servers required for keeping constant the JOB response time which is set in the initial parameter setting 100 can be determined from the average JOB request interval and JOB execution time.

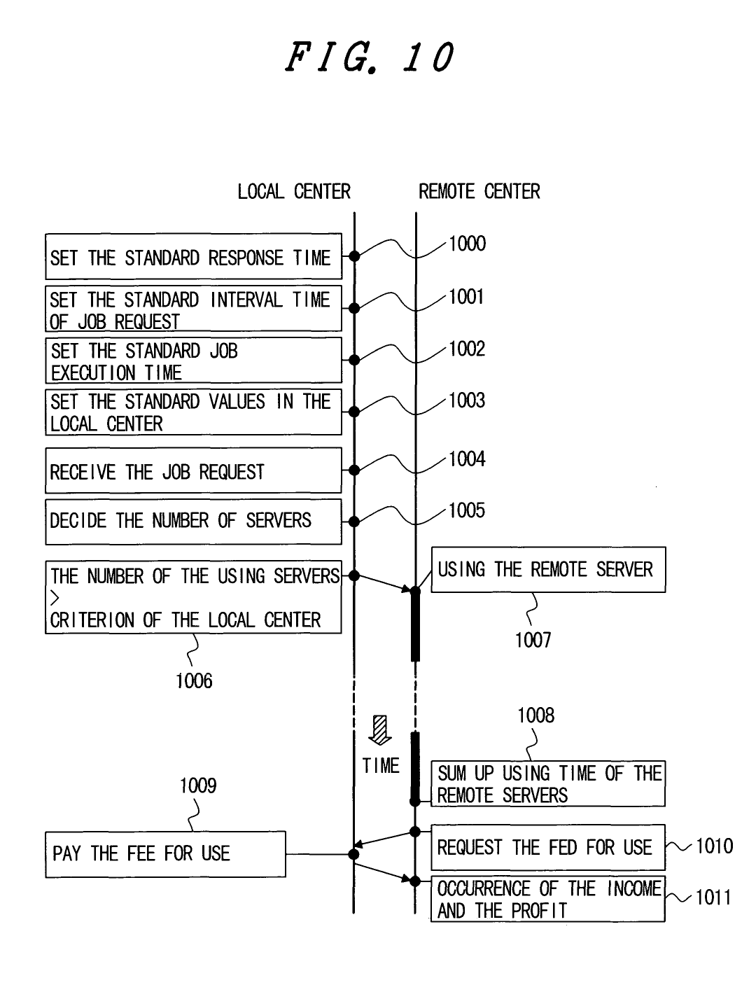

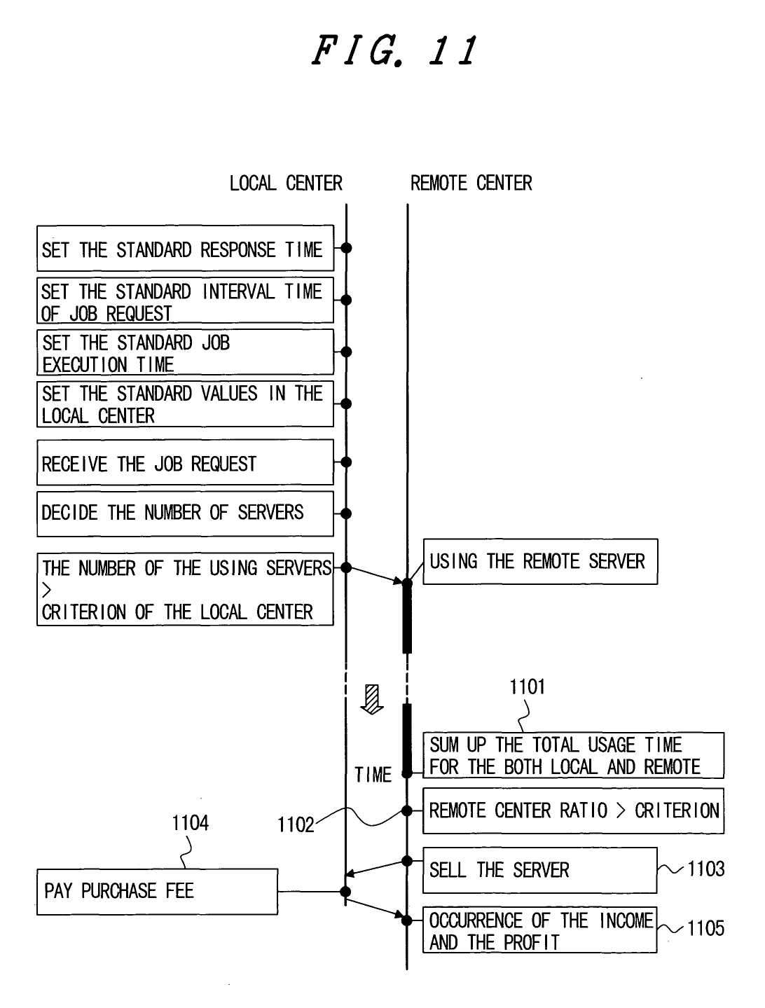

Referring to FIG. 10, an embodiment of business using the present invention is explained. Two vertical lines in the center of FIG. 10 shows the time series of processes in the local center and remote servers. In the local center, as shown in FIG. 2, a standard response time is set (1000), and a standard JOB request time interval is set (1001), so that a standard JOB execution time is set (1003). After that, reception of JOB requests starts, and the necessary number of the servers is determined every time a JOB request occurs (1005). Next, when the number of the servers is over a criterion of the servers of the local center (1006), the servers of the remote center are used (1007). In the remote center, usage times of the servers are summed up by each user or each Computer Service Center (in FIG. 10, local center) to which JOB requests are transmitted (1008). Fees for the usage times are requested (1010). The local center pays the fees (1009), and the income and the profit occur in the remote center (1011). As a result, a JOB beyond computer resource capability of the local center can be executed by the support of the remote centers, and the remote centers can do business.

FIG. 11 shows another business embodiment. In FIG. 11, the remote center sums up the total usage time for the servers of the local center and remote centers within a predetermined period (1101). A ratio of a usage time for a JOB run by the local center to the total usage time (in FIG. 11, a “remote center ratio” for the remote center) is calculated. The remote center ratio and a predetermined criterion are compared (1102). When the ratio is over the criterion, the remote center sells the servers to the local center (1103). As a result, the local center pays money as the server purchase fee to the remote center (1104), the income and the profit occur in the remote center (1105).

According to the present invention, without depending on load information, the necessary number of servers, which number is required for achieving a desired response time, is calculated to determine JOB assignment/distribution, and only when the necessary number is over JOB process capability, the remote center can be used.

What is claimed is:

1. A JOB distributing method in a distributed computer system where a plurality of Computer Service Centers each having a plurality of servers are connected via a network, comprising the steps of:
predetermining a desired JOB response time at the computer system, a criterion of the number of servers operating at a first Computer Service Center, a standard JOB request interval at the first Computer Service Center, and a standard JOB execution time of the servers;
calculating a current average JOB request interval when a JOB request occurs at the first Computer Service Center;
calculating the necessary number of servers required for achieving the desired JOB response by inputting the standard JOB request interval, the standard JOB execution time, and the calculated current average JOB request interval; and
executing a JOB of the JOB request in the servers of the first Computer Service Center when the necessary number of the servers is within the criterion of the number of the servers at the first Computer Service Center, and transmitting the JOB request from the first Computer Service Center to a second Computer Service Center, by comparing the necessary number and the criterion of the number of the servers at the first Computer Service Center.

2. The method of claim 1, wherein the current average JOB request interval is an average interval of JOB requests observed during a predetermined period until a current time.

3. The method of claim 1, wherein the second Computer Service Center authenticates a user by whom the JOB request occurs, and charges the user for a JOB execution time of the JOB request.

4. The method of claim 1 further comprising the steps of:
predetermining, at the second Computer Service Center, the desired JOB response time, a criterion of the number of the servers operating in the second Computer Service Center, a standard JOB request interval in the second Computer Service Center, and a standard JOB execution time of the servers at the second Computer Service Center;
calculating a current average JOB request interval of the second Computer Service Center when the JOB request is transmitted to the second Computer Service Center;
calculating the necessary number of the servers at the second Computer Service Center for achieving the desired JOB response time by inputting the standard JOB request interval in the second Computer Service Center, the standard JOB execution time of the servers at the second Computer Service Center, and the current average JOB request interval of the second Computer Service Center; and
executing a JOB of the JOB request in the second Computer Service Center when the necessary number is within the criterion of the number of the servers at the second Computer Service Center, and transmitting the JOB request to a third Computer Service Center when the necessary number is over the criterion, by comparing the necessary number and the criterion of the number of the servers at the second Computer Service Center.

5. The method of claim 4, wherein values of the standard JOB request interval in the second Computer Service Center and the standard JOB execution time of the servers at the second Computer Service Center are the same as the standard JOB request interval in the first Computer Service Center and the standard JOB execution time of servers at the first Computer Service Center.

6. A server resource transaction method in a computer system where each of a plurality of Computer Service Center has a plurality of servers, comprising the steps of:
calculating a current average JOB request interval of a first Computer Service Center when a JOB request occurs in the first Computer Service Center;
calculating the necessary number of servers for achieving a predetermined JOB response time from a predetermined standard JOB request interval, a predetermined standard JOB execution time, and the calculated current average JOB request interval;
transmitting the JOB request from the first Computer Service Center to a second Computer Service Center when the necessary number of the servers is over a criterion predetermined at the first Computer Service Center;
causing the second Computer Service Center to substitutively execute the JOB request transmitted from the first Computer Service Center; and
charging the first Computer Service Center by calculating a fee of the substitutive execution within a predetermined period of the second Computer Service Center.

7. The method of claim 7, wherein the second Computer Service Center calculates a ratio of the substitutive execution time to the total server usage time within the predetermined period, and the second Computer Service Center is charged for the purchase fee of the servers when the ratio is over a predetermined criterion.
